(19) United States
(12) Patent Application Publication
(10) Pub. No.: US 2018/0023492 A1
(43) Pub. Date: Jan. 25, 2018

(54) FUEL SUPPLY CONTROL SYSTEM FOR V-TYPE TWO-CYLINDER GENERAL PURPOSE ENGINE

(71) Applicant: NIKKI CO., LTD., Kanagawa-ken (JP)

(72) Inventors: Shouta Tanigawa, Kanagawa - ken (JP); Takaya Kohara, Kanagawa-ken (JP); Toshiaki Nakaza, Kanagawa - ken (JP)

(21) Appl. No.: 15/657,086

(22) Filed: Jul. 21, 2017

(30) Foreign Application Priority Data
Jul. 22, 2016 (JP) 2016-144829

(51) Int. Cl. F02D 41/04

(52) U.S. Cl. CPC F02D 41/04; F02D 2200/021; F02D 2200/0406; F02D 2200/101; F02D 2200/0814

(57) ABSTRACT

A fuel supply control system for a V-type two-cylinder general purpose engine according to the present disclosure, in a V-type two-cylinder general purpose engine including one fuel injection valve in a throttle body disposed upstream via an intake manifold connected to a cylinder head of each cylinder, changes an injection frequency or an operation timing of the fuel injection valve in accordance with an engine operation state detected by a detection unit.

### CROSS-REFERENCE TO RELATED APPLICATION

This application claims priority to a Japanese Patent Application No. 2016-144829 filed on Jul. 22, 2016, the contents of which are hereby incorporated by reference in its entirety.

### BACKGROUND

The present invention relates to a fuel supply control system for a V-type two-cylinder general purpose engine to be used in a lawnmower, a power generator, a power machine for marine sports, and the like.

### Related Art

There has been known a conventional general purpose engine used in a lawnmower, a power generator, a power machine for marine sports, and the like. In particular, the general purpose engine is required to be a small size and a low cost according to purposes of use, and a carburetor is used in most of the engines as a fuel supply unit.

However, it is extremely difficult to include a function conforming to recent exhaust emission measures for engines in the carburetor due to mechanism limitation. In particular, a balance of a mixing ratio of fuel and air (air fuel ratio) in a two-cylinder engine, in other words, a cylinder distribution, is easily varied, and therefore the carburetor is independently disposed for each cylinder.

In addition, for example, in a multicylinder engine used in, for example, high-price vehicles, exhaust emission control measures are taken, and a cylinder is distributed, by supplying a fuel to an engine by injecting the fuel from a fuel injection valve in an intake passage of the engine, instead of a carburetor. In particular, when a fuel injection valve is disposed in each branch pipe of an intake manifold, specifically, in a multi point injection (MPI) method, a fuel supply amount can be controlled for each cylinder. However, the fuel supply apparatus becomes expensive, and it is difficult to use the fuel supply apparatus in a general purpose engine required to lower the price.

Therefore, for example, Japanese Unexamined Patent Application Publication No. 2003-106246 (PTL 1) proposes a fuel supply apparatus for a general purpose engine, which supplies a fuel by one fuel injection valve disposed in an area between two intake passages connected to each cylinder of a two-cylinder engine.

In the fuel supply apparatus for a general purpose engine proposed in Japanese Unexamined Patent Application Publication No. 2003-106246, costs are reduced by using a single point injection (SPI) method for injecting a fuel to each cylinder of a two-cylinder engine by using one fuel injection valve. However, as illustrated in FIG. 7, one fuel injection valve 11a is disposed upstream of throttle bodies 2a and 2a in which a throttle valve 5a connected to an intake manifold 3a including two branch pipes M₁ and M₂ connected to each of two cylinders C₁ and C₂ of a two-cylinder engine 4a are disposed in two passage portions T₁ and T₂. A cost reduction by reducing the number of parts by disposing the fuel injection valve 11a in the throttle body 2a can be confirmed. However, the number of parts is not sufficiently reduced since the intake manifold 3a including two branch pipes M₁ and M₂ connected to the cylinder of the engine, and also the throttle body 2a in which two throttle valves 5a and 5a are disposed is needed. Further, fuel guide passages F₁ and F₂ in which a fuel injected from the fuel injection valve 11a to the passage portions T₁ and T₂ are needed. Therefore, the fuel supply apparatus has a complicated configuration as a whole, and manufacturing is not easy.

In particular, since the intake manifold 3a including the throttle valves 5a and 5a and the branch pipes M₁ and M₂ is disposed on a downstream side after a branch in the fuel injection valve 11a. Therefore, even if a fuel injected from one fuel injection valve 11a is divided into the fuel guide passage F₁ and F₂ by dividing into two by an accurate structure, air fuel ratios in cylinders might vary when the fuel reaches to the cylinders since an intake amount is changed in accordance with an engine load. Further, the fuel supply apparatus proposed in Japanese Unexamined Patent Application Publication No. 2003-106246 can be disposed in a parallel-type two-cylinder engine having a space for disposing a fuel supply apparatus between cylinders. However, the fuel supply apparatus is not easily disposed in a further downsized V-type two-cylinder general purpose engine since a space between engine heads is narrow.

Further, Japanese Unexamined Utility Model Application Publication No. S63-87271 (PTL 2) proposes a fuel supply apparatus in which a throttle valve is disposed upstream of a fuel injection valve and proposes a fuel supply apparatus which supplies a sprayed fuel injected from a fuel injection valve to each cylinder by guiding the fuel from a riser portion to right and left intake branch pipes. However, the fuel supply apparatus cannot be applied in an air-cooled general purpose engine which does not includes a riser portion.

Furthermore, examples of a V-type two-cylinder general purpose engine include a vertical output shaft type engine used in such as a riding mower and a horizontal output shaft type engine used in such as a power generator. In an intake manifold of the vertical output shaft type engine and an intake manifold of the horizontal output shaft type engine, a mounting angle of a throttle body is different by 90 degree. Therefore, in the case where throttle bodies mounting fuel injection valves having a same configuration are used, an injection direction of a fuel injected from a fuel injection valve does not match an intake manifold of each type. Therefore, a throttle body separately needs for each output shaft-type intake manifold. Consequently, there is a problem in aspect of the improvement of a production efficiency by commonly using parts.

As illustrated in FIG. 1, a fuel supply apparatus 1 including one intake manifold 4, one throttle body 5, and one fuel injection valve 6 is proposed. In the intake manifold 4, an opening 42 is formed. The opening 42 is branched in a direction of both cylinders 3 and 3 across a second line segment L2 vertical to a first line segment L1 in the middle of the first line segment L1 connecting between center lines C1 and C1 in the cylinder heads 31 and 31 of the cylinders 3 and 3 in the V-type two-cylinder general purpose engine 2. In the intake manifold 4, intake ports 33 and 33 symmetrically formed across the second line segment L2 are connected to each of opening portions 41 and 41 disposed at both ends. The throttle body 5 includes an intake hole connected to the opening 42 of the intake manifold 4 and extending in the second line segment L2 direction and a throttle valve disposed in the intake hole. The fuel injection valve 6 includes a two-way nozzle. The two-way nozzle is disposed on a downstream side from a throttle valve in an intake hole formed in the throttle body 5. The two-way nozzle equally injects a fuel in the intake ports 33 and 33 of the cylinders 3 and 3 through the opening 42 of the intake manifold 4 or on inner wall surfaces of the intake ports 33 and 33 and disposed opposite to each other toward an outer side.

The fuel supply apparatus 1 satisfies emission gas regulations by uniformly distributing a fuel to each of the cylinder heads 31 and 31 with a small number of parts and at a low cost. Further, the fuel supply apparatus 1 can be disposed in a V-type two-cylinder general purpose engine in which a space between the engine heads 31 and 31 is narrow. The fuel supply apparatus 1 is simply designed, parts are commonly used, and remodeling is simple, since the opening 42 formed to the intake manifold 4 can mount a carburetor in instead of the throttle body 5. Further, a cylinder distribution can be optimized without having a difference in air fuel ratios in the cylinders 3 and 3.

However, in the fuel supply apparatus 1, one fuel injection valve 6 is operated by synchronizing with strokes of the cylinders 3 and 3. Therefore, in the case where an injection valve designed by assuming a maximum displacement engine is used for a minimum displacement engine, a flow rate cannot be reduced, and an optimum air fuel ratio cannot be obtained, in an operation state in which a flow rate of a fuel intermittently injected from the fuel injection valve with a light load needs to be reduced to a minimum ratio. Therefore, it is difficult that one type of the fuel injection valve is used for various types of V-type two-cylinder general purpose engines with various engine displacements since a balance between an injection rate and an engine displacement or a time controllable under operation conditions is limited.

### SUMMARY

An object of the present invention is to provide a fuel supply control system. In the fuel supply control system, in the case where a fuel injection valve designed by assuming a maximum displacement engine is used for a minimum displacement engine, a problem is solved that a flow rate cannot be reduced, and an optimum air fuel ratio cannot be obtained in an operation state in which a flow rate of a fuel intermittently injected from the fuel injection valve with a light load needs to be reduced to a minimum ratio. The fuel supply control system can be applied in V-type two-cylinder general purpose engines with a small engine displacement to a maximum engine displacement by using one type of a fuel injection valve.

In the present invention for solving the above-described object, a fuel supply control system in a V-type two-cylinder general purpose engine includes one fuel injection valve in a throttle body disposed upstream via an intake manifold connected to a cylinder head of each cylinder. In the fuel supply control system, an injection frequency or an operation timing of the fuel injection valve is changed in accordance with an engine operation state detected by a detection unit.

Further, in the present invention, the detection unit to detect the engine operation state is an intake pressure sensor, an engine rotation sensor, an engine temperature sensor, and an oxygen sensor. Further, in the case where an injection frequency of the fuel injection valve is once or twice, and a shift criteria is shifted from once to twice, an OR condition is applied, and in the case where the injection frequency of the fuel injection valve is shifted from twice to once, an AND condition is applied.

Furthermore, in the case where an injection frequency of the fuel injection valve is twice, an injection is performed from an exhaust stroke to an intake stroke of each cylinder, and in the case where an injection frequency of the fuel injection valve is once, the injection starts in the middle of the intake stroke of each cylinder.

According to the present invention, a same type of a fuel injection valve can be used for middle and small-sized engines. In an operation area with light to medium loads when the injection is performed once, an operation is performed at a theoretical air-fuel ratio. Consequently, a theoretical air-fuel ratio feedback control is performed by an oxygen sensor disposed in an exhaust pipe, and a stable engine operation is realized.

### BRIEF DESCRIPTION OF DRAWINGS

FIG. 1 is a sectional view illustrating a V-type two-cylinder general purpose engine to practice the present invention;

FIG. 2 is a simple block circuit diagram illustrating an operation state of a fuel injection by each type of sensors in the V-type two-cylinder general purpose engine illustrated in FIG. 1;

FIG. 3 is a diagram describing an example of the AND theory according to an embodiment of the present invention;

FIG. 4 is a diagram describing an example of the OR theory according to the embodiment of the present invention;

FIG. 5 is a relation diagram from an exhaust stroke to an intake stroke of each cylinder in the case where an injection frequency of a fuel injection valve according to the embodiment of the present invention is once and twice;

FIG. 6 is a relation diagram between a fuel injection flow rate and a fuel injection width in the embodiment of the present invention; and

FIG. 7 is a view describing a conventional example.

### DETAILED DESCRIPTION

Next, a preferred embodiment of the present invention will be described.

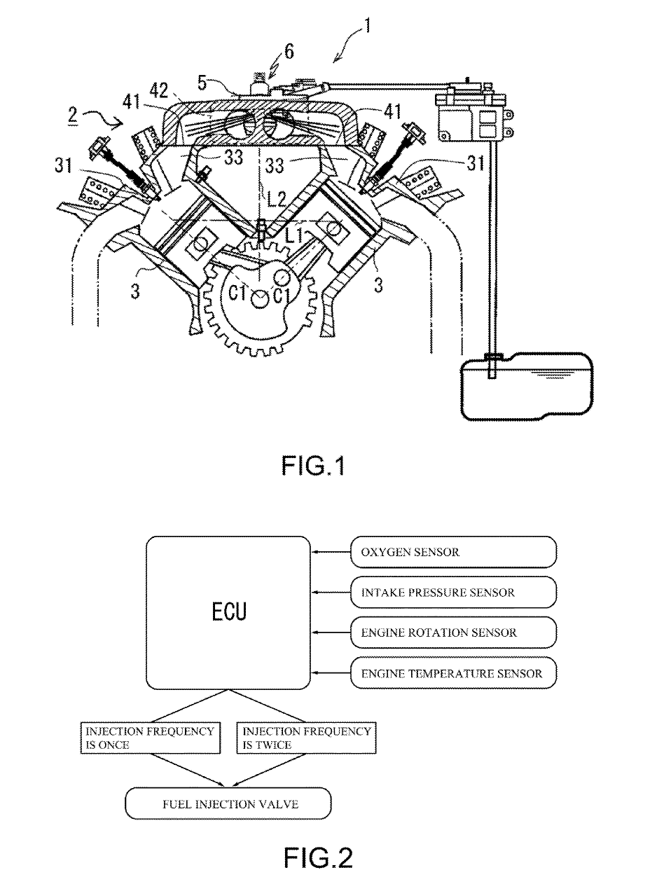

Regarding an embodiment of the present invention, a configuration is same as in the V-type two-cylinder general purpose engine 2 illustrated in FIG. 1. One fuel injection valve 6 is included in the throttle body 5 disposed upstream via the intake manifold 4 connected to the cylinder heads 31 and 31 of the cylinders 3 and 3.

Then, in the embodiment, as illustrated in FIG. 2, a detection signal from an intake pressure sensor, an engine rotation sensor, an engine temperature sensor, and an oxygen sensor which is a detection unit to detect an engine operation state is received by an ECU, and an injection frequency or an operation timing of a fuel injection valve is changed in accordance with predetermined conditions.

Further, more specifically, engine load information is detected by the intake pressure sensor, and the ECU reflects the signal to a valve opening time of the fuel injection valve. In addition, an engine stroke is identified by the rotation sensor, and an injection is performed at a predetermined injection timing. The engine temperature sensor measures an engine warming-up state and is used to correct an extension of a valve opening time of an injection valve, for example, at cold start. As described above, the oxygen sensor is used to detect a concentration of a combustion exhaust gas during theoretical air-fuel ratio control.

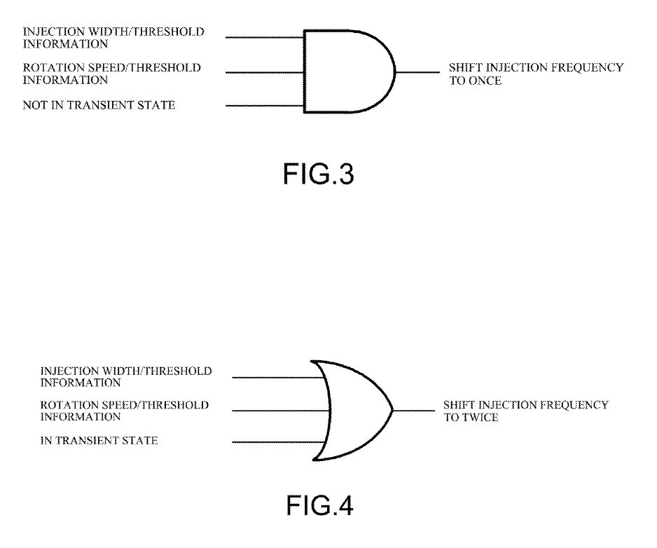

In particular, in the control system, an injection frequency of a fuel injection valve is once or twice. As illustrated in FIG. 3, an engine operation is performed at an injection pattern in which an injection is performed once when three conditions are satisfied (an AND condition): when a load is light, in other words, when it is determined that a valve opening time of the fuel injection valve is short with respect to a predetermined threshold (or a value of an intake pressure sensor is low); when an rotation speed is an arbitrary speed; and when an engine is not in a transient response state (acceleration and deceleration).

Further, as illustrated in FIG. 4, when even one of the three conditions is not satisfied (an OR condition), the injection pattern is shifted to a pattern in which an injection is performed twice. As a result, a stable engine operation is realized without entering an immovable area on a small flow rate side of a fuel injection valve. Further, one type of the fuel injection valve can be used in small to large displacement engines.

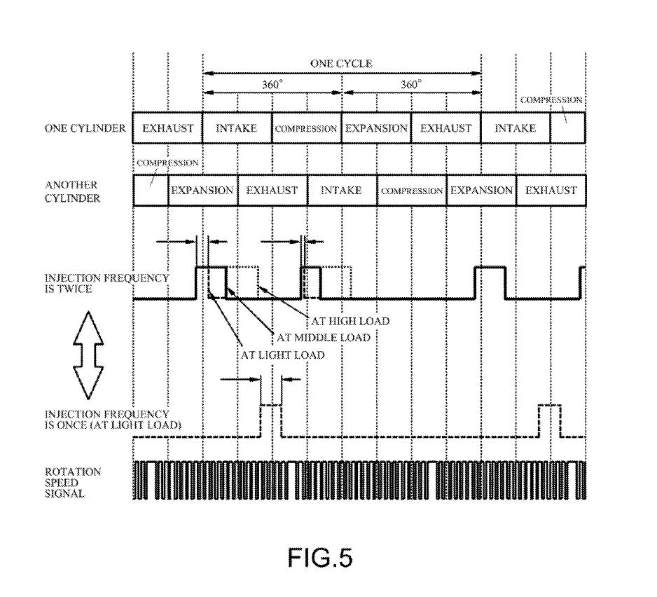

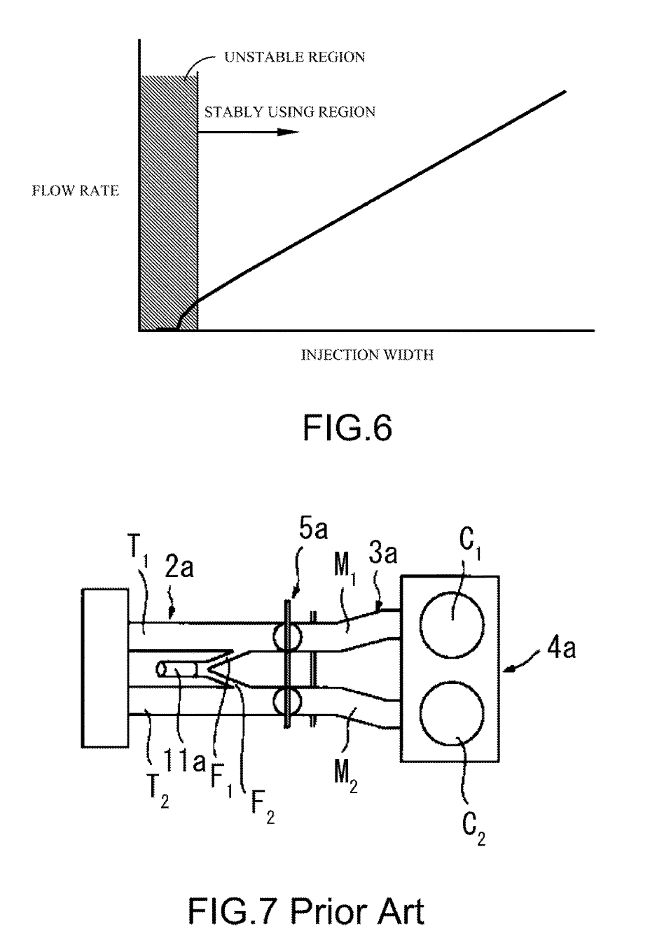

FIG. 5 illustrates a preferred embodiment indicating a relation between an injection timing and an injection time when an injection is performed twice and once in intake/exhaust strokes of each cylinder. FIG. 6 indicates a relation between a fuel injection flow rate and a fuel injection width. A flow rate of a fuel injection valve is designed with a specification in which a maximum flow rate is required in engine variations. In the case where the fuel injection valve is used in the largest engine, an injection is performed twice in the whole of an engine operation area. In the case where the fuel injection valve is used in small or middle-sized engines, the injection is performed twice in an operation area in which relatively a large amount of fuels in a medium load area and a high load area is required. In a light load area, a flow rate during a minimum driving time of the injection valve which intermittently injects and supplies a fuel is excessively increased with respect to a required flow rate of an engine. Therefore, an engine operation becomes difficult. Specifically, a flow rate of a fuel to be supplied to each cylinder needs to be reduced.

Therefore, although a fuel has been injected and supplied twice to each cylinder, a fuel supply frequency is reduced to once, and a fuel is supplied to each cylinder at a total flow rate. As a result, a valve opening time of an injection valve can be extended to an available time.

An injection timing is synchronized with past intake timings of cylinders, and fuel supply is started in the middle to the end of an intake stroke of one of the cylinders. While forming an appropriate mixing ratio with respect to the cylinder, a valve close time with respect to another cylinder is also controlled. Consequently appropriate fuel supply is performed. As a result, a valve opening time of an injection valve certainly extends when an injection is performed once in comparison with the case where the injection is performed twice, and the same-type of a fuel injection valve can be used for middle and small-sized engines.

In an operation area with light to medium loads when the injection is performed once, an operation is performed at a theoretical air-fuel ratio. Consequently, a theoretical air-fuel ratio feedback control is performed by an oxygen sensor disposed in an exhaust pipe, and a stable engine operation is realized.

On the other hand, it is considered that the fuel injection valve is used in middle and small-sized engines, and the whole of an operation area is controlled by injecting once. However, generally an engine is often set in a state in which a fuel concentration is increased in comparison with a theoretical air-fuel ratio with medium to high loads in which output is needed. In this case, the theoretical air-fuel ratio feedback control using an oxygen sensor cannot be performed, and open loop control is performed.

In the case of the open loop control, a fuel injection valve operates based on a valve opening command from a rotation signal. Therefore, an injection timing may be changed due to each variation factor including an assembly variation of a rotation sensor on an engine side and a working variation of an engine cam.

The change during the opening loop control similarly affects in the case where an injection frequency is once in the case where the injection frequency is twice.

However, when the injection frequency is once, the change generally affects, in other words, directly affects a fuel supply amount to both cylinders. When the injection frequency is twice, the change is slightly caused between exhaust strokes or intake strokes of each cylinder and does not much affect the cylinder.

Therefore, in comparison with the case where the whole area is controlled by injecting once, when the injection is performed once in a light load area only in which the theoretical air-fuel ratio feedback control is effective, and the injection is performed twice in medium to high load area, a robustness is highly kept with respect to a manufacturing variation on an engine parts side.

1. A fuel supply control system for a V-type two-cylinder general purpose engine, comprising a fuel injection valve in a throttle body disposed upstream via an intake manifold connected to a cylinder head of each cylinder,
wherein, in the fuel supply control system, an injection frequency or an operation timing of the fuel injection valve is changed in accordance with an engine operation state detected by a detection unit.

2. The fuel supply control system for a V-type two-cylinder general purpose engine according to claim 1,
wherein the detection unit to detect the engine operation state includes an intake pressure sensor, an engine rotation sensor, an engine temperature sensor, and an oxygen sensor.

3. The fuel supply control system for a V-type two-cylinder general purpose engine according to claim 1,
wherein in a case where an injection frequency of the fuel injection valve is once or twice, and a shift criteria is shifted from once to twice, an OR condition is applied, and
in a case where the injection frequency of the fuel injection valve is shifted from twice to once, an AND condition is applied.

4. The fuel supply control system for a V-type two-cylinder general purpose engine according to claim 1,
wherein in a case where an injection frequency of the fuel injection valve is twice, an injection is performed from an exhaust stroke to an intake stroke of each cylinder, and
in a case where an injection frequency of the fuel injection valve is once, the injection starts in the middle of the intake stroke of each cylinder.

5. The fuel supply control system for a V-type two-cylinder general purpose engine according to claim 2,
wherein in a case where an injection frequency of the fuel injection valve is once or twice, and a shift criteria is shifted from once to twice, an OR condition is applied, and
in a case where the injection frequency of the fuel injection valve is shifted from twice to once, an AND condition is applied.

6. The fuel supply control system for a V-type two-cylinder general purpose engine according to claim 2,
wherein in a case where an injection frequency of the fuel injection valve is twice, an injection is performed from an exhaust stroke to an intake stroke of each cylinder, and
in a case where an injection frequency of the fuel injection valve is once, the injection starts in the middle of the intake stroke of each cylinder.

7. The fuel supply control system for a V-type two-cylinder general purpose engine according to claim 3,
wherein in a case where an injection frequency of the fuel injection valve is twice, an injection is performed from an exhaust stroke to an intake stroke of each cylinder, and
in a case where an injection frequency of the fuel injection valve is once, the injection starts in the middle of the intake stroke of each cylinder.
